(19) United States
(12) Patent Application Publication
(10) Pub. No.: US 2005/0284269 A1
(43) Pub. Date: Dec. 29, 2005

(54) Auxiliary connector of ratchet wrench

(76) Inventor: Kun-Chih Hung, Ta Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/873,246

(22) Filed: Jun. 23, 2004

(51) Int. Cl. B25B 13/58; B25B 13/00

(52) U.S. Cl. 81/180.1; 81/177.2; 81/177.85

(57) ABSTRACT

An auxiliary connector of the present invention is mounted on a head of a ratchet wrench. The head has a first connector, which is a rectangular column, and a second connector, which is a round column with a hole. The auxiliary connector is consisted of a main member and a wheel. The main member has a first connection portion, which is a polyhedral column, at an end thereof, a second connection portion, which is a round column, at an opposite end thereof, and a conjunction portion, which is a stair-like portion, between the first connection portion and the second connection portion. The wheel has a through hole to be fitted to the main member at the conjunction portion.

### BACKGROUND OF THE INVENTION

1. Field of the Invention

The present invention relates generally to a connector of a ratchet wrench, and more particularly to an auxiliary connector of the ratchet wrench, which is fitted to the wrench so that the wrench is operated at opposite sides thereof.

2. Description of the Related Art

As shown in FIG. 6 and FIG. 7, a conventional auxiliary connector 10 of a ratchet wrench 6 is mainly consisted of a first connector 71 and a second connector 72, wherein the first connector 71 is a rectangular column and the second connector 72 has a through hole 721, a ball 722 received in a sidewall of the through hole 721 and an annular spring plate 723.

Aforesaid ratchet wrench 6 is applied broadly because of the first connector 71 and the second connector 72. The first connector 71 is connected with a sleeve barrel and the second connector 72 is connected with a screwdriver. Like many ratchet wrenches, aforesaid ratchet wrench is not applied to a loose nut or bolt. The ratchet function only work in a condition that the nut (or bolt) has a resistance to keep the ratchet member still while the wrench turns reversibly. Under such condition, user usually turns the nut directly by fingers. But the maximum sizes of the first and the second connectors 71 and 72 are 7 mm to 10 mm, so that it is hard to turn the nut by fingers. An improved ratchet wrench provides a wheel 8 with a rectangular hole to be fitted to the first connector 71, so that user can grip the wheel 8 to turn the loose nut.

A problem of the improved ratchet wrench is that the rectangular hole of the wheel 8 can not be fitted to the second connector 72. Therefore, while the first connector 71 is engaged with a sleeve barrel to turn a nut, user has to turn the second connector 72.

Another problem of the wheel 8 is that user usually grips the wheel 8 by thumb and forefinger and while the wheel 8 is connected to the first connector 71, the wheel 8 is located at the same side with the handle of the wrench that is vary hard for fingers to grip the wheel 8.

### SUMMARY OF THE INVENTION

The primary objective of the present invention is to provide an auxiliary connector of a ratchet wrench, which has connection portions to be inserted into connectors to be applied to various types of sleeve barrels.

The second primary objective of the present invention is to provide an auxiliary connector of a ratchet wrench, which has a wheel fitted to the connection portions respectively capable of turning both of the connectors via the wheel.

According to the objective of the present invention, an auxiliary connector of the present invention is mounted on a head of a ratchet wrench. The head has a first connector, which is a rectangular column, and a second connector, which is a round column with a hole. The auxiliary connector is consisted of a main member and a wheel. The main member has a first connection portion, which is a polyhedral column, at an end thereof, a second connection portion, which is a round column, at an opposite end thereof, and a conjunction portion, which is a stair-like portion, between the first connection portion and the second connection portion. The wheel has a through hole to be fitted to the main member at the conjunction portion.

### BRIEF DESCRIPTION OF THE DRAWINGS

FIG. 1 is a sectional view of a preferred embodiment of the present invention;

FIG. 2 is a sectional view of the ratchet wrench on which the auxiliary connector of the preferred embodiment of the present invention is mounted in a first condition;

FIG. 3 is a sectional view of the ratchet wrench on which the auxiliary connector of the preferred embodiment of the present invention is mounted in a second condition;

FIG. 4 and FIG. 5 are sectional view of the ratchet wrench with the auxiliary connector of the preferred embodiment of the present invention in operation;

FIG. 6 is a sectional view of the ratchet wrench with the conventional auxiliary connector, and

FIG. 7 is a sectional view of the conventional auxiliary connector in operation.

### DETAILED DESCRIPTION OF THE INVENTION

As shown in FIGS. From FIG. 1 to FIG. 5, an auxiliary connector 1, as shown in FIG. 1, is mainly consisted of a main member 2 and a wheel 3 fitted to the main member 2. The main member 2 has a first connection portion 21, which is a polyhedral column, at an end thereof and a second connection portion 22, which is a round column, at the other end thereof. There is a stair-like portion at a conjunction portion of the first connection portion 21 and the second connection portion 22 and the conjunction portion has a surface 23 with a texture portion 231. The wheel 3 has a through hole 31 at a center thereof to be fitted to the conjunction portion of the first and the second connection portions 21 and 22.

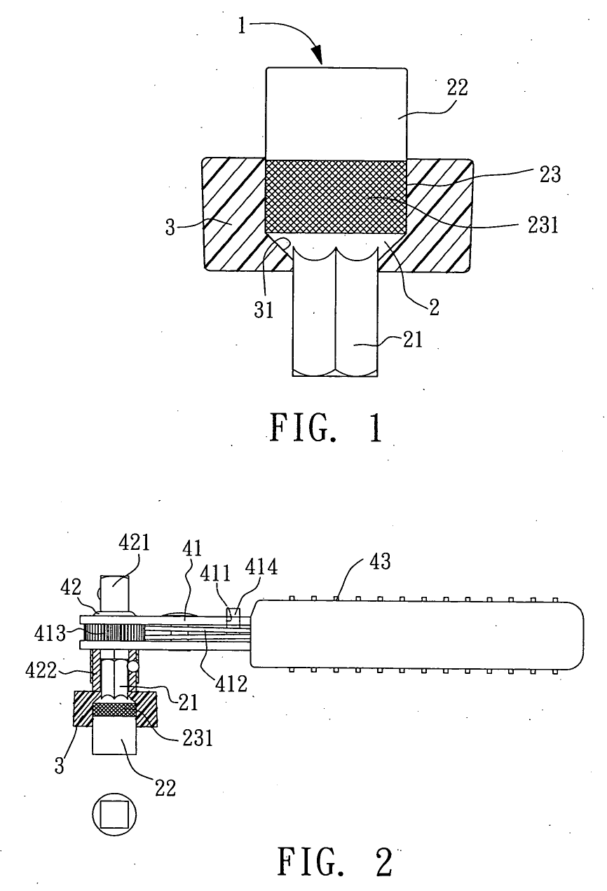

The auxiliary connector 1 is mounted on a ratchet wrench 4, as shown in FIG. 2. The ratchet wrench 4 has a base 41, a head 42 and a handle 43. The base 41 has a slot 411 in which a shaft 412 and a ratchet member 413 are mounted. The shaft 412 is in contact with the ratchet member 413. The shaft 412 has a projection 414 to be extruded out of the base 41 via the slot 411. The head 42 has a first connector 421 and a second connector 422. The head 32 is received in the base 41 and the ratchet member 413 for rotation. The handle 43 is provided at the side opposite to the head 42. While the ratchet wrench 4 is engaged with various sleeve barrels, the second connection portion 22 is engaged with the first connector 421, as shown in FIG. 3, to change the first connector 421 into the first connection portion 21. The first connection portion 21 is capable of connecting various sleeve barrels so as to increase the applications of the ratchet wrench 4. On the contrary, the first connection portion 21 is inserted into the second connector 22, as shown in FIG. 2, to change second connector 422 into the second connection portion for engagement of the various sleeve barrels.

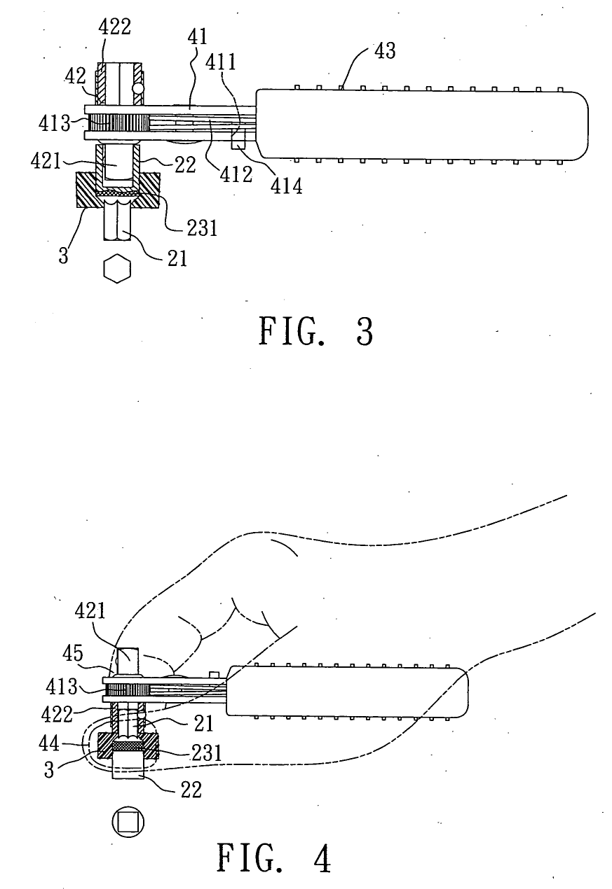

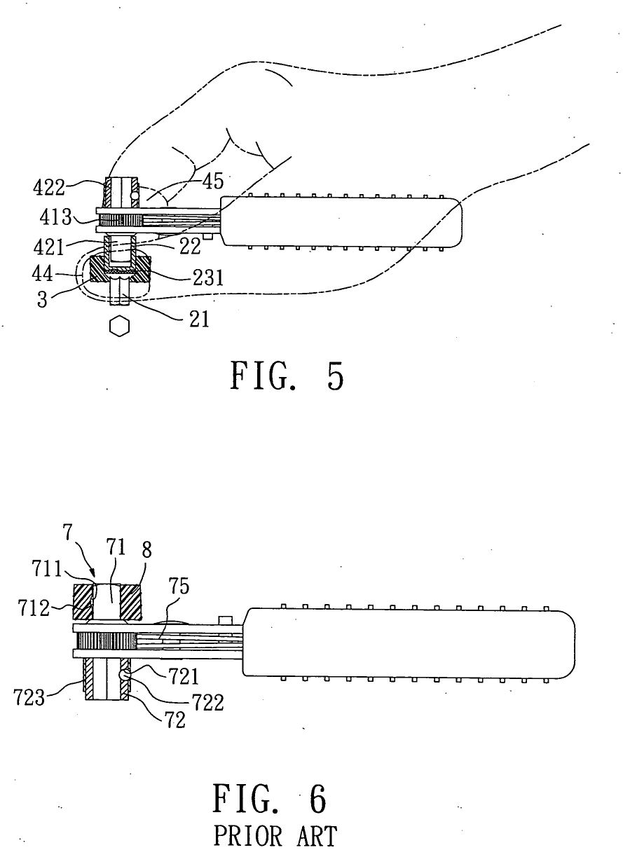

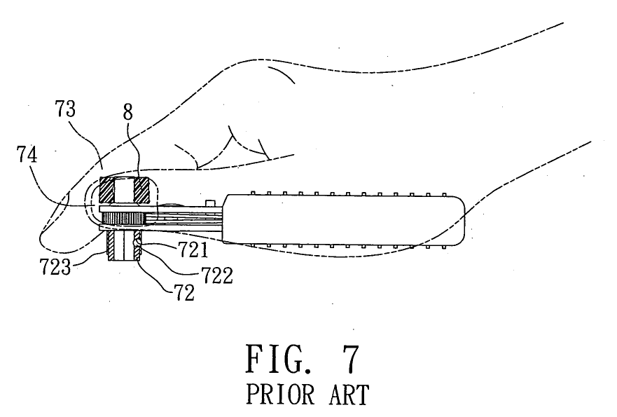

As shown in FIG. 4 and FIG. 5, the auxiliary connector 1 has the wheel 3 fitted to the conjunction portion of the first and the second connection portions 21 and 22 in an interference fit to let user has a thumb 44 and a forefinger 45 gripping the wheel 3. The location of the wheel 3 is kept still no matter the auxiliary connector 1 has the first connection portion 21 or second connection portion 22 engaged with the wrench 4. The wheel 3 of the present invention meets the requirement of ergonomics that facilitates user to turn the auxiliary connector 1 by fingers.

1. An auxiliary connector, which is mounted on a head of a ratchet wrench, wherein the head has a first connector, which is a rectangular column, and a second connector, which is a round column with a hole, comprising:
a main member having a first connection portion, which is a polyhedral column, at an end thereof, a second connection portion, which is a round column, at an opposite end thereof, and a conjunction portion, which is a stair-like portion, between the first connection portion and the second connection portion, and
a wheel having a through hole to be fitted to the main member at the conjunction portion.

2. The auxiliary connector as defined in claim 1, wherein the through hole has a round portion and polyhedral portion respectively at opposite ends thereof to be fitted to the first connector and the second connector of the ratchet wrench respectively.

3. The auxiliary connector as defined in claim 2, wherein the conjunction portion of the main member has a surface on which a texture portion is formed to be fitted to the wheel in an interference fit.
